(19) United States
(12) Patent Application Publication
(10) Pub. No.: US 2014/0363671 A1
(43) Pub. Date: Dec. 11, 2014

(54) MEDIUM- OR HIGH-VOLTAGE ELECTRIC CABLE

(71) Applicant: NEXANS, Paris (FR)

(72) Inventors: Jerome Alric, L'isle D'abeau (FR); Arnaud Allais, Limas (FR); Yannick Goutille, Villeurbanne (FR); Jerome Fournier, Lyon (FR)

(21) Appl. No.: 14/373,420

(22) PCT Filed: Jan. 23, 2013
(86) PCT No.: PCT/FR2013/050139

§ 371 Date: Jul. 21, 2014

(30) Foreign Application Priority Data
Jan. 23, 2012 (FR) 12 50634

(51) Int. Cl. H01B 7/282; H01B 9/00

(52) U.S. Cl. CPC H01B 7/282; H01B 9/00
USPC 428/383; 428/379

(57) ABSTRACT

The invention relates to an electric cable (1) comprising an elongate electrical conductor (2) surrounded by a non-cross-linked layer of a grafted polymer material that is obtained from a polymer composition comprising: at Least one polyolefin composition comprising: at least one polyolefin and a compound intended to be grafted to the polyolefin. The cable is characterized in that the compound to be grafted is a grafting in that the compound to be grafted is grafting compound comprising at least one epoxy group and a single reactive function which can be grafted to the polyolefin.

The present invention relates to an electric cable comprising an elongated electrical conductor surrounded by a noncrosslinked polymeric layer.

It typically but not exclusively applies to the fields of medium-voltage power cables (in particular from 6 to 45-60 kV) or to high-voltage power cables (in particular of greater than 60 kV and which can range up 10 to 800 kV) , whether they are direct current or alternating current cables.

Medium- or high-voltage power cables typically comprise a central electrical conductor and, successively and coaxially around this electrical conductor., an inner semiconducting layer, an electrically insulating intermediate layer and an outer semiconducting layer. These layers are based on polymer (s) and may or may not be crosslinked.

The discontinuity in the electrical properties between the electrically insulating layer and the semiconducting layers of this type of cable can result in a local reinforcing of the electrical field by accumulation of space charge or of charged entities capable of initiating treeing under the action of an electric field.

In particular, the presence of moisture in combination with the presence of an electric field with a polymer material promotes the gradual deterioration in the insulating properties of said medium- and high-voltage power cables.

This deterioration mechanism, well known under the term “water treeing”, can thus lead to the breakdown of the electric cable concerned and thus constitutes a considerable threat with regard to the reliability of the power transmission network with well-known economic consequences brought about by short circuits.

In particular, it is difficult to optimally limit water treeing when the semiconducting and electrically insulating layer are noncrosslinked layers, as a result of the reduced physico-chemical cohesion between the polymer chains.

The aim of the present invention is to overcome the disadvantages of the techniques of the prior art by providing an electric cable comprising at least one noncrosslinked polymeric layer, intended in particular to be used in the field of medium-voltage or high-voltage power cables, exhibiting a breakdown resistance which is significantly improved after aging, in particular in a wet environment, in the presence of a direct or alternating electric field (typically greater than 25 kV/mm), these conditions being conventionally favorable to the formation of electrically charged entities.

A subject matter of the present invention is an electric cable comprising an elongated electrical conductor surrounded by a noncrosslinked layer, or in other words a thermoplastic layer, of a grafted polymer material, which layer is obtained from a polymeric composition comprising: at least one polyolefin an a compound intended to be grafted to the polyolefin, characterized in that said compound intended to be grafted is a grafting compound comprising at least one epoxy group a single reactive functional group capable of grafting to the polyolefin. Preferably, the single reactive functional group is different from the epoxy group.

A noncrosslinked polymer material of the polyolefin grafted with epoxy groups type is thus obtained.

The grafting compound is used in the present invention as agent for delaying water treeings.

By virtue of the invention, the noncrosslinked layer makes it possible to significantly limit the water treeings as a result, of the presence of the grafting compounds grafted along the macromolecular chain of the polyolefin, More particularly, this relates to the resistance to electrical breakdown and in particular to the ability to dissipate the space charges which accumulate in particular in nigh-voltage cables under direct current.

Furthermore, in order to guarantee the most optimum properties as agent, for delaying water treeings, the grafting conditions employed to graft the grafting compound to the polyolefin preferably do not make possible the opening of the epoxy group.

In addition, the noncrosslinked layer of the grafted polymer material of the invention exhibits the advantage of being economic and easy to process, in particular by extrusion, and to manufacture, since it does not require recourse to lengthy and expensive crosslinking processes. Furthermore, it can advantageously be easily recycled.

Furthermore, as a result of the presence of a single reactive functional group, said grafting compound cannot participate in the crosslinking of the polyolefin.

The grafting compound of the invention is preferably an organic compound other than a polymer. In other words, the grafting compound in particular does not result from the covalent linking of a large number of identical or different monomer units. More particularly, the grafting compound does not result from the covalent linking of at least two identical or different monomer units.

According to the invention, said reactive Functional group of the grafting compound can be an unsaturated functional group (i.e., unsaturated carbon-carbon bond) and preferably a vinyl functional group and particularly preferably an ethylenic functional group of the CH₂=CH— type.

The epoxy group of the grafting compound can, for its part, be an oxirane group (i.e., an ethylene oxide group).

Preferably, the grafting compound according to the invention can be chosen from glycidyl esters.

Mention may be made, as preferred example, of glycidyl methacrylate (GMA) (i.e., 2,3-epoxy-1-propanol methacrylate).

The polymeric composition of the invention can comprise at most 5% by weight of grafting compound. Preferably, it can comprise from 0.1% to 3% by weight of grafting compound.

In order to obtain the grafted polymer material according to the invention, the grafting compound is grafted along the macromolecular chain (i.e., main chain or backbone) of said polyolefin by techniques well known to a person skilled in the art. The ends of the macromolecular chain of the polyolefin for their part may or may not be grafted with said grafting compound.

According to the present invention, the compound intended to be grafted to the polyolefin can be grafted directly or indirectly to the polyolefin.

Direct Grafting:

According to a first alternative form of the invention, the grafted polymer material is obtained by grafting the grafting compound directly to the polyolefin. In other words, the grafted polymer material is obtained by grafting the grafting compound without the intermediacy of a coupling agent positioned between said grafting compound and the polyolefin.

In a first example of the implementation of said first alternative form, this type of grafting can be carried out conventionally by using a grafting agent, the grafting of the grafting compound to the polyolefin then being carried out according to a radical mechanism initiated by the grafting agent.

The grafting agent can, for example, be an organic peroxide. Said organic peroxide is added in an amount sufficient to make possible the grafting of the grafting compound to the polyolefin, while substantially preventing the crosslinking of said polyolefin.

For example, the polymeric composition can comprise at most 1% by weight of a grafting agent, and preferably at most 0.5% by weight of a grafting agent.

In a second example of an implementation of said first alternative form, this type of grafting can be carried out conventionally by electron beams (i.e., “e-beam”), in particular by β-rays.

This technique is well known to a person skilled in the art and the latter can easily choose the most appropriate parameters, such as the power of the irradiation, the nature of the irradiation (e.g., α, β, γ, and the like) and the duration of the irradiation, in order to obtain the grafted polymer material.

Typically, this second implementational example preferably does not comprise a grafting agent as defined above and more particularly does not comprise an organic peroxide.

Indirect Grafting via a Coupling Agent:

According to a second alternative form of the invention, the grafted polymer material is obtained by indirectly grafting the grafting compound to the polyolefin. In other words, the grafted polymer material is obtained by grafting the grafting compound via a coupling agent positioned between said grafting compound and the polyolefin.

On this account, the polymeric composition of the invention can additionally comprise a coupling agent.

The coupling agent facilitates the (indirect) grafting of the grafting compound to the polyolefin.

The coupling agent can comprise a single reactive functional group capable of grafting to the polyolefin.

Thus, as a result of the presence of said single reactive functional group, said coupling agent would not be able to participate in the crosslinking of the polyolefin.

Said reactive functional group of the coupling agent can be an unsaturated functional group (i.e., unsaturated carbon-carbon bond) and preferably a vinyl functional group and particularly preferably an ethylenic functional group of the CH₂=CH— type.

The coupling agent can be an aromatic compound comprising at least one aromatic nucleus and said single reactive functional group capable of grafting to the polyolefin. The single reactive functional group is preferably other than the aromatic nucleus.

The coupling agent of the invention is preferably a compound other than a polymer. In other words, the coupling agent in particular does not. result from the covalent linking of a large number of identical or different monomer units. More particularly, the coupling agent does not result from the covalent linking of at least two identical or different monomer units.

Said aromatic nucleus can more particularly be a monocyclic or polycyclic aromatic hydrocarbon. It can be chosen from a benzene ring and a benzene derivative,

The aromatic compound can be a compound represented by the following general formula (I):

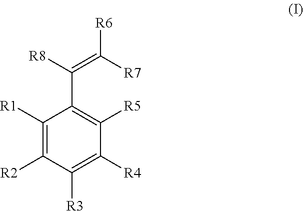

in which the R1 to R8 groups are chosen, independently of one another, from a hydrogen atom, an alkyl group (preferably of 1 to 8 carbon atoms) and an aryl group (preferably a benzene derivative or a phenylalkyl group).

The aromatic compound can be chosen from styrene, styrene derivatives and their isomers, or one of their mixtures.

According to a first embodiment, the R6 and R7 groups of the formula I are hydrogen atoms. Mention may be made, by way of example, of vinylbenzene or 4-methyl-2,4-diphenylpentene as one of the styrene derivatives.

According to a second embodiment, the R6 or the R7 group, or the R6 and R7 groups, of the formula I is/are other than a hydrogen atom. By way of example, the aromatic compound of the invention can be triphenylethylene.

In the context of the present invention, it may also be considered that one of the styrene derivatives can be chosen from polycyclic aromatic hydrocarbons (PAHs).

More particularly, mention may be made, as PAH, of:
vinylnaphthalene, such as, for example, 2-vinylnaphthalene;
vinylanthracene, such as, for example, 9-vinylanthracene or 2-vinylanthracene; and
vinylphenanthrene, such as, for example, 9-vinylphenanthrene, or one of their mixtures.

In an advantageous embodiment, the polymeric composition of the invention can comprise at most 8.0% by weight of coupling agent and preferably at most 5.0% by weight of coupling agent. Particularly preferably, it can comprise from 0.1% to 2.0% by weight of coupling agent. This value as percentage by weight can be applied more particularly when the composition comprises at least 60% by weight of polymer(s), preferably at least 80% by weight of polymer(s) and preferably at least 90% by weight of polymer(s).

More particularly, the polymeric composition of the invention can comprise at most 8.0 parts by weight of coupling agent per 100 parts by weight of polymer(s) in the polymeric composition and preferably at most 5.0 parts by weight of coupling agent, per 100 parts by weight of polymer(s) in the polymeric composition.

Particularly preferably, it can comprise from 0.1 to parts by weight of coupling agent per 100 parts by weight of polymer(s) in the polymeric composition.

Particularly preferably, the amount of coupling agent in the composition is equimolar with that of the amount of grafting compound.

When the composition according to the invention additionally comprises a coupling agent, it is preferable for it to also comprise a grafting agent, the grafting of the coupling agent, on the polyolefin then taking place according to a radical mechanism initiated by the grafting agent.

The grafting agent can, for example, be an organic peroxide. Said organic peroxide is added in an amount sufficient to make possible the grafting of the grafting compound to the polyolefin, while substantially preventing the crosslinking of said polyolefin.

For example, the polymeric composition can comprise at most 1% by weight of a grafting agent and preferably at most 0.5% by weight of a grafting agent.

In the present invention, the term “polymeric composition” is understood to mean a composition obtained from one or more organic polymers, making it possible in particular to shape it by extrusion.

The polymeric composition of the invention comprises at least one polyolefin. The term “polyolefin” as such means, generally, olefin polymer of the olefin homopolymer or copolymer type. Preferably, said olefin polymer is a noncyclic olefin polymer.

In the present invention, it will be preferable to use an ethylene polymer (ethylene homo- or copolymer) or a propylene polymer (propylene homo- or copolymer).

Mention may be made, as example of ethylene polymers, of linear low density polyethylene (LLDPE), low density polyethylene (LDPE), medium density polyethylene (MDPE), high density polyethylene (HDPE), ethylene and vinyl acetate copolymers (EVAs), ethylene and butyl acrylate copolymers (EBAs), ethylene and methyl acrylate copolymers (EMAs), ethylene and 2-hexylethyl acrylate copolymers (2HEAs), ethylene and α-olefin copolymers, such as, for example, polyethylene/octenes (PEOs) or polyethylene/butenes (PEBs), ethylene and propylene copolymers (EPRs), such as, for example, ethylene/propylene/diene terpolymers (EPDMs), and their mixtures,

It will be preferable to use a high density polyethylene (HDPE), a low density polyethylene (LDPE) or a propylene homopolymer (PP).

The polymeric composition of the noncrosslinked layer of the invention can comprise more than 50.0 parts by weight of polyolefin per 100 parts by weight of polymer(s) (i.e. polymer matrix) in the composition, preferably at least 70 parts by weight of polyolefin per 100 parts by weight of polymer(s) in said composition and particularly preferably at least 90 parts by weight, of polyolefin per 100 parts by weight of polymer(s) in said composition.

Particularly advantageously, the constituent polymer or polymers of the polymeric composition of the noncrosslinked layer are solely one or more polyolefins. In this case, it will be preferable to use a single type of polyolefin in the composition, such as an HDPE, an LDPE or a PP.

The polymeric composition according to the invention can additionally comprise at least one protective agent, such as an antioxidant. Antioxidants make it possible to protect the composition from the thermal stresses brought about during the stages of manufacture of the cable or of operation of the cable.

Other additives and/or other fillers well known to a person skilled in the art can also be added to the polymeric composition of the invention, such as scorch retardants; processing aids, such as lubricants or waxes; compatibilizing agents; coupling agents; UV stabilizers; nonconducting fillers; conducting fillers; and/or semiconducting fillers.

In a particularly preferred embodiment, the noncrosslinked layer of the invention can comprise less than 50 parts by weight of inorganic flame-retardant filler, in particular of the aluminum trihydroxide (ATH), magnesium dihydroxide (MDH) and/or hydrotalcite type, per 100 parts by weight of grafted polymer material, preferably less than 20 parts by weight of inorganic flame-retardant filler per 100 parts by weight of grafted polymer material and particularly preferably the noncrosslinked layer of the invention comprises substantially no inorganic flame-retardant filler.

More particularly, the noncrosslinked layer of the invention can comprise less than 50 parts by weight of inorganic flame-retardant filler, in particular of aluminum trihydroxide (ATH), magnesium dihydroxide (MDH) and/or hydrotalcite type, per 100 parts by weight of polymer(s) in the polymeric composition, preferably less than 20 parts by weight of inorganic flame-retardant filler per 100 parts by weight of polymer(s) in the polymeric composition and particularly preferably the noncrosslinked layer of the invention comprises substantially no inorganic flame-retardant filler.

Thus, this type of noncrosslinked layer, comprising no or little inorganic flame-retardant filler, makes possible advantageous application in medium- or high-voltage power cables.

The noncrosslinked layer according to the invention can be easily characterized by the determination of its gel content according to the standard ASTM D2765-01. More particularly, said noncrosslinked layer can advantageously have a gel content, according to the standard ASTM D2765-01, of at most 20%, preferably of at most 10%, preferably of at most 5% and particularly preferably of 0%. The “noncrosslinked” layer thus exhibits the advantage of having a significantly improved electrical resistance to breakdown. Generally, a “crosslinked” layer can exhibit a gel content of at least 60%, according to the standard ASTM D2765-01.

In a particularly preferred embodiment, the electric cable according to the present invention can comprise a first semiconducting layer (referred to as “inner layer” surrounding the elongated electrical conductor, a second electrically insulating layer-surrounding the first, layer and a third semiconducting layer (referred to as “outer layer”) surrounding the second layer, at least one of these three layers being the noncrosslinked layer of the invention.

According to a preferred embodiment, the noncrosslinked layer of the invention is the electrically insulating layer (i.e., second layer). In the case of the electrically insulating layer, the crosslinkable composition does not comprise, preferably, (electrically) conducting filler and/or does not comprise semiconducting

More particularly, at least two of the three layers of the cable are noncrosslinked layers and preferably the three layers of the cable are noncrosslinked layers.

When the polymeric composition is used in the manufacture of the semiconducting layers (first layer and/or third layer), the noncrosslinkable composition additionally comprises at least one (electrically) conducting filler or one semiconducting filler, in an amount sufficient, to render the polymeric composition semiconducting.

It will more particularly be considered that a material is electrically insulating when its electrical conductivity is at most 1×10⁻⁹ S/m.

It will more particularly be considered that a material is semiconducting when its electrical conductivity is at least 1×10⁻³ S/m.

The polymeric composition used in order to obtain a semiconducting material can comprise from 0.1% to 40% by weight of (electrically) conducting filler, preferably at least 15% by weight of conducting filler and more preferably still at least 25% by weight of conducting filler.

The conducting filler can advantageously be chosen from carbon blacks, carbon nanotubes and graphites, or one of their mixtures.

Whether these are the first semiconducting layer, the second electrically insulating layer and/or the third semiconducting layer, at least one of these three layers can be an extruded layer, preferably two of these three layers are extruded layers and more preferably still these three layers are extruded layers.

In a specific embodiment, generally in accordance with the electric cable well known in the field of application of the invention, the first semiconducting layer, the second electrically insulating layer and the third semiconducting layer constitute a three-layer insulation. In other words, the second electrically insulating layer is directly in physical contact with the first semiconducting layer and the third semiconducting layer is directly in physical contact with the second electrically insulating layer.

The electric cable of the invention can additionally comprise a metallic shield surrounding the third semiconducting layer.

This metallic shield can be a “wire” shield composed of an assembly of conductors made of copper or aluminum arranged around and along the third semiconducting layer, a “strip” shield composed of one or more conducting metal strips positioned helically around the third semiconducting layer, or a “leaktight” shield of metal tube type surrounding the third semiconducting layer. The latter type of shield makes it possible in particular to form a barrier to the moisture which has a tendency to penetrate the electric cable in a radial direction.

All the types of metallic shield can play the role of earthing the electric cable and can thus transmit fault currents, for example in the event of short-circuit in the network concerned.

In addition, the electric cable of the invention can comprise an external protective sheath surrounding the third semiconducting layer or else more particularly surrounding said metallic shield, when it exists. This external protective sheath can be made conventionally from appropriate thermoplastic materials, such as HDPEs, MDPEs or LLDPEs; or also materials which can retard flame propagation or withstand propagation of fire. In particular, if the latter materials do not comprise halogen, reference is made to sheathing of HFFR (Halogen-Free Flame Retardant) type.

Other layers, such as layers which expand in the presence of moisture, can be added between the third semiconducting layer and the metallic shield, when it exists, and/or between the metallic shield and the external sheath, when they exist, these layers making it possible to ensure the longitudinal and/or transverse leaktightness toward water of the electric cable. The electric cable of the invention can also comprise materials which expand in the presence of moisture in order to obtain a “leaktight core”.

The electrical conductivity of the electric cable of the invention is improved in particular by the presence of the aromatic rings.

Another subject. matter is the use of the noncrosslinked layer of an electric cable of the invention to limit water treeings in alternating or direct current.

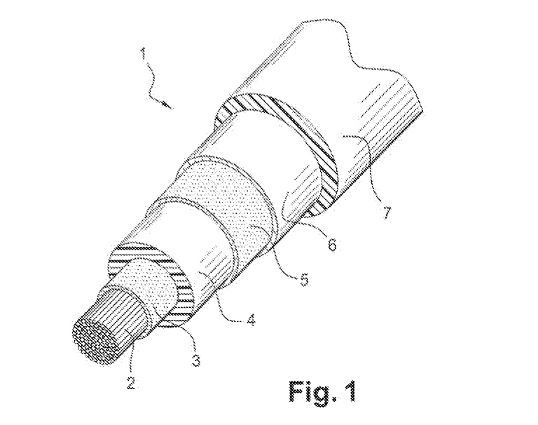

Other characteristics and advantages of the present invention will become apparent in the light of the description of a nonlimiting example of an electric cable according to the invention made with reference to FIG. 1, which represents a diagrammatic view in perspective of an electric cable according to a preferred embodiment in accordance with the invention.

For reasons of clarity, only the components essential for the understanding of the invention have been represented diagrammatically and without respecting a scale.

The medium- or high-voltage power cable 1, illustrated in FIG. 1, comprises an elongated central conducting component 2, in particular made of copper or aluminum. The power cable 1 additionally comprises several layers positioned successively and coaxially around this conducting component 2, namely: a first semiconducting layer 3 referred to as “inner semiconducting layer”, a second electrically insulating layer 4, a third semiconducting layer 5 referred to as “outer semiconducting layer”, an earthing and/or protective metallic shield 6 and an external protective sheath 7, it being possible for the layers 3, 4 and 5 to be obtained from a polymeric composition according to the invention. The layers 3, 4 and 5 are extruded and noncrosslinked layers.

The presence of the metallic shield 6 and of the external protective sheath 7 is preferred but not essential, this cable structure being as such well known to a person skilled in the art.

### EXAMPLES

1. Direct Grafting by β Radiation

The composition according to the invention comprises the following compounds:
100 parts by weight of a polyolefin of the propylene and ethylene copolymer type, sold by Lyondellbasell under the reference Hifax CA7441A, and
1.1 parts by weight of a grafting compound of the glycidyl methacrylate (GMA) type, sold by Dow Chemicals, with respect to 100 parts by weight of polyolefin.

Said compounds are mixed and shaped using a Leistritz twin-screw extruder. Granules are obtained at the outlet of the extruder.

The granules are then placed in an electron bombardment device in order to irradiate the granules with 10 kGy (kilogray) β rays.

Consequently, after irradiation, a polymer material grafted with epoxy groups is obtained.

In order to confirm that the grafting of the GMA has indeed been carried out, the grafted GMA content is measured by infrared spectroscopy. There exists other techniques (solely qualitative), such as, for example, the measurement of the viscosity which makes it possible to compare, on the one hand, the viscosity of the composition which has been subjected to said 10 kGy β irradiation and, on the other hand, this same composition but which has not been subjected to any irradiation.

It is noticed that the viscosities are completely

different, which confirms that the grafting of the GMA to the macromolecular chain of the polyolefin has indeed taken place by virtue of the p irradiation.

2. Indirect Grafting using a Coupling Agent

The composition according to the invention comprises the following compounds:
100 parts by weight of a polyolefin of low density polyethylene (LDPE) type, sold by Ineos under the reference BPD-2000,
3 parts by -weight of a grafting compound of

the glycidyl methacrylate (GMA) type, sold by Dow Chemicals, per 100 parts by weight of polyolefin,
0.3 part by weight of a grafting agent, of the organic peroxide type, sold by AkzoNobel under the reference Perkadox BC-FF, per 100 parts by weight, of polyolefin, and
a coupling agent of the styrene type (i.e., vinylbenzene—CAS No. 100-42-5), sold by Sigma-Aldrich, in an amount equimolar with the amount of GMA, namely 2.1 parts by weight of said coupling agent per 100 parts by weight of polyolefin.

Said compounds are mixed and shaped using a Leistritz twin-screw extruder. More particularly, once the polyolefin is introduced into the extruder, a pump is used to introduce the mixture consisting of styrene, GMA and organic peroxide and to thus form the composition according to the invention.

The temperatures within the extruder have to allow the peroxide to decompose, in order to be able to graft the styrene to the macromolecular chain of the LDPE. On this account, the temperatures are greater than 170° C. and can reach 220° C.

The grafting of the GMA to the polyethylene takes place according to the following radical mechanism:

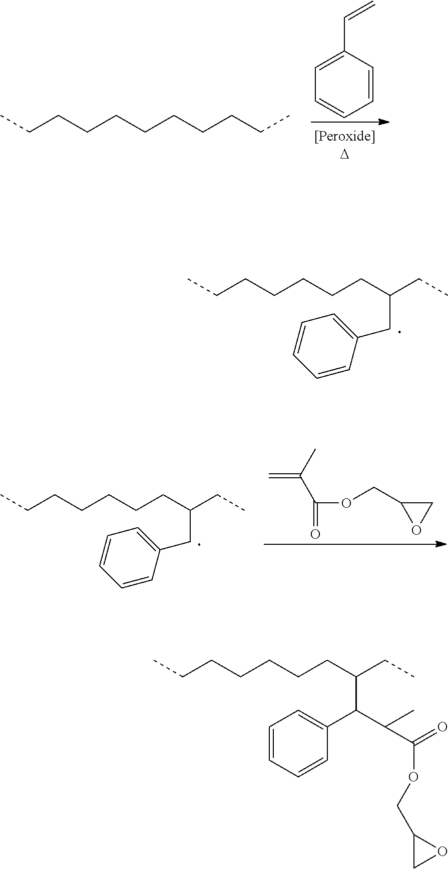

Thus, the processing of the composition according to the invention at a temperature which makes it possible to decompose the peroxide makes it possible to obtain a composition comprising coupling agents grafted to the LDPE and in particular grafted to the macromolecular chain of the LDPE, these coupling agents then facilitating the grafting of the grafting agent to said coupling agent by the radical route.

Consequently, at the extruder outlet, a polymer material grafted with epoxy groups is obtained.

1. An electric cable comprising;
an elongated electrical conductor surrounded by a noncrosslinked layer of a grafted polymer material, said layer obtained from a polymeric composition having:
at least one polyolefin; and
a compound intended to be grafted to the polyolefin, wherein said compound intended to be grafted is a grafting compound with at least one epoxy group and a single reactive functional group capable of grafting to the polyolefin.

2. The cable as claimed in claim 1, wherein the single reactive functional group of the grafting compound is an unsaturated functional group.

3. The cable as claimed in claim 2, wherein the unsaturated functional group is a vinyl functional group.

4. The cable as claimed in claim 1, wherein the epoxy group is an oxirane group.

5. The cable as claimed in claim 1, wherein the grafting compound is chosen from glycidyl esters.

6. The cable as claimed in claim 5, wherein the grafting compound is glycidyl methacrylate.

7. The cable as claimed in claim 1, wherein the grafted polymer material is obtained by grafting the grafting compound directly to the polyolefin.

8. The cable as claimed in claim 7, wherein the grafting of the grafting compound to the polyolefin is carried out by electron beams.

9. The cable as claimed in claim 1, wherein the grafted polymer material is obtained by indirectly grafting the grafting compound to the polyolefin,

10. The cable as claimed in claim 9, wherein the composition additionally comprises a coupling agent comprising a single reactive functional group capable of grafting to the polyolefin,

11. The cable as claimed in claim 10, wherein the coupling agent is an aromatic compound chosen from styrene, styrene derivatives and their isomers, or one of their mixtures.

12. The cable as claimed in claim 1, wherein the noncrosslinked layer has a gel content, according to the standard ASTM D2765-01, of at most 20% and preferably of at most 10%.

13. The cable as claimed in claim 1, wherein said cable has first semiconducting layer surrounding the electrical conductor, a second electrically insulating layer surrounding the first layer and a third semiconducting layer surrounding the second layer, at least one of these three layers being the noncrosslinked layer.

14. A method of preventing water treeing in an electric cable, said method comprising the steps of:
applying at least one noncrosslinked layer as defined in claim 1.
